(19) United States
(12) Patent Application Publication
(10) Pub. No.: US 2017/0318268 A1
(43) Pub. Date: Nov. 2, 2017

(54) CHANGE DEGREE DERIVING DEVICE, CHANGE DEGREE DERIVING SYSTEM AND KNOWN COLOR BODY

(71) Applicant: FUJI XEROX CO., LTD., Tokyo (JP)

(72) Inventors: Hitoshi OGATSU, Kanagawa (JP); Shinji SASAHARA, Kanagawa (JP); Junichi MATSUNOSHITA, Kanagawa (JP); Ken OGINO, Kanagawa (JP)

(73) Assignee: FUJI XEROX CO., LTD., Tokyo (JP)

(21) Appl. No.: 15/359,003

(22) Filed: Nov. 22, 2016

(30) Foreign Application Priority Data
May 2, 2016 (JP) 2016-092708

(51) Int. Cl. H04N 9/04

(52) U.S. Cl. CPC H04N 9/04; G06T 2207/10024; G06T 2207/30204

(57) ABSTRACT

Provided is a change degree deriving device including a receiving unit that receives an image obtained by capturing an object and a known color body, the known color body including plural color samples each of which has a known colorimetric value, and a position checking section used to check a relative position of the known color body with respect to the object, a conversion rule generating unit that generates a conversion rule used to convert a color of the image received by the receiving unit into a numerical value in a device-independent color space, based on the color samples included in the image received by the receiving unit, and a converting unit that converts a color of the object included in the image received by the receiving unit into a numerical value in the device-independent color space according to the conversion rule.

### CROSS-REFERENCE TO RELATED APPLICATIONS

This application is based on and claims priority under 35 USC 119 from Japanese Patent Application No. 2016-092708 filed May 2, 2016.

### BACKGROUND

### Technical Field

The present invention relates to a change degree deriving device, a change degree deriving system and a known color body.

### SUMMARY

According to an aspect of the invention, there is provided a change degree deriving device including:

a receiving unit that receives an image obtained by capturing an object and a known color body, the known color body including plural color samples each of which has a known colorimetric value, and a position checking section used to check a relative position of the known color body with respect to the object;

a conversion rule generating unit that generates a conversion rule used to convert a color of the image received by the receiving unit into a numerical value in a device-independent color space, based on the color samples included in the image received by the receiving unit; and a converting unit that converts a color of the object included in the image received by the receiving unit into a numerical value in the device-independent color space according to the conversion rule.

### BRIEF DESCRIPTION OF THE DRAWINGS

Exemplary embodiments of the present invention will be described in detail based on the following figures, wherein:

FIG. 1 is a diagram illustrating a deterioration measuring system according to an exemplary embodiment of the present invention;

FIG. 2 is a plan view illustrating a known color body used in the exemplary embodiment of the present invention;

FIG. 3 is a diagram illustrating a relationship between the known color body and an object used in the exemplary embodiment of the present invention;

FIG. 4 is a block diagram illustrating hardware of a deterioration measuring device according to the exemplary embodiment of the present invention; and

FIG. 5 is a flow chart illustrating a processing flow of the deterioration measuring device according to the exemplary embodiment of the present invention.

### DETAILED DESCRIPTION

Hereinafter, an exemplary embodiment of the present invention will be described in detail with reference to the accompanying drawings.

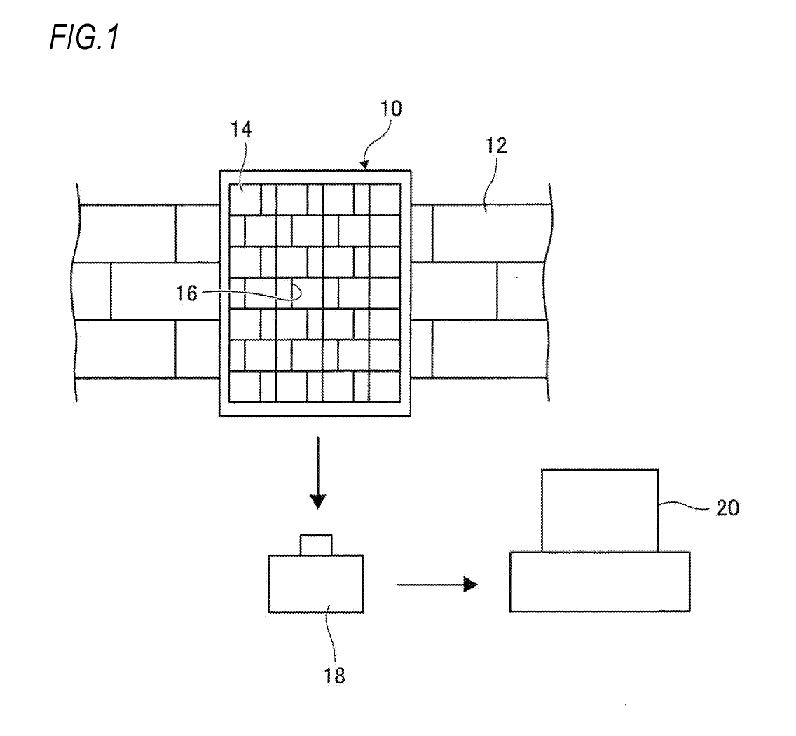

FIG. 1 is a diagram illustrating a change degree derivation according to an exemplary embodiment of the present invention. Hereinafter, descriptions will be made assuming that a deterioration of an object is measured, and the change degree derivation is replaced by a “deterioration measurement” in the description.

A known color body 10 is fixed to an object 12 that is, for example, a wall face of a structure through pasting or the like. The known color body 10 includes plural color samples 14. Also, an object capturing hole 16 is formed at the center of the known color body 10.

An image capturing device 18 is a digital camera, a smartphone, a tablet PC, or the like, and captures the known color body 10. Since the object capturing hole 16 is formed in the known color body 10, the image capturing device 18 captures the wall face 12 through the object capturing hole 16, together with the known color body 10.

A deterioration measuring device 20, which is, for example, a personal computer, receives image data obtained by capturing the known color body 10 using the image capturing device 18, and process the image data.

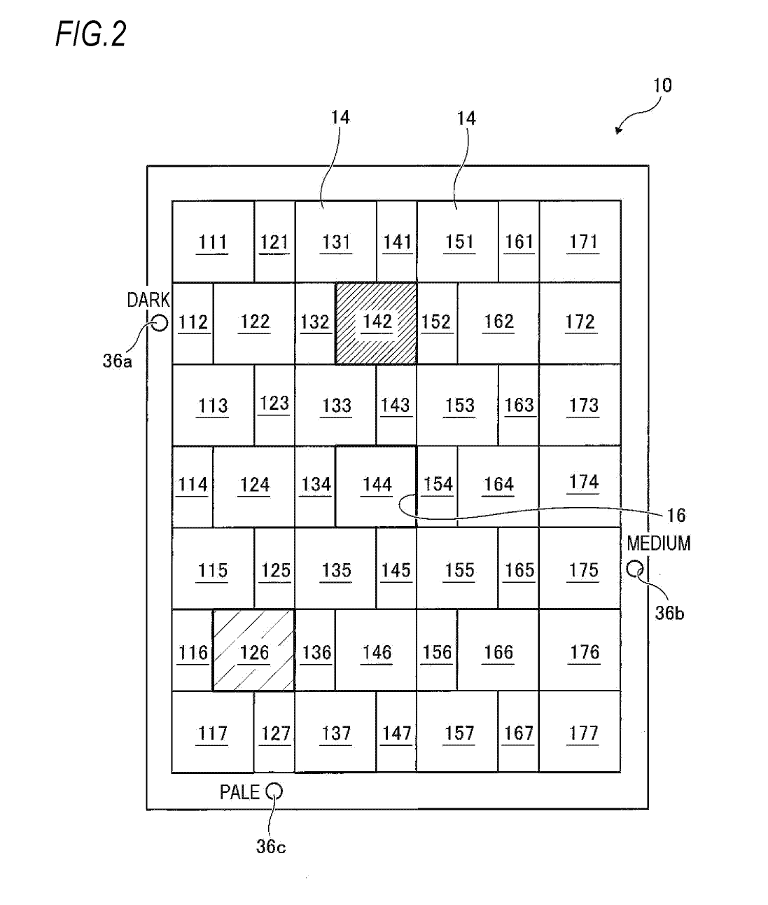

FIG. 2 illustrates details of the known color body 10.

On the known color body 10, plural color samples (patches) 14 as denoted by, for example, Nos. 111 to 177 are regularly arranged at predetermined positions. The color samples Nos. 111 to 177 include square color samples Nos. 111, 113, 115 . . . and rectangular color samples Nos. 112, 114, 116 . . . . The square color samples Nos. 111, 113, 115 . . . may include 100% solids of R (red), G (green), B (blue), C (cyan), M (magenta), Y (yellow), W (white), Bk (black), and the intermediate colors thereof.

Also, the square color samples Nos. 111, 113, 115 . . . include plural deterioration-series color samples. The deterioration-series refer to a series of a gradually deteriorated color in an object to be measured. Here, the color sample No. 142 has a color of the object in a new product state, and the color sample No. 126 has a color in a deteriorated state. The deterioration-series color samples Nos. 142 and 126 are arranged around the object capturing hole 16, inside peripheral edges. That is, these are placed in an environment close to the object in the vicinity of the object capturing hole 16.

The rectangular color samples Nos. 112, 114, 116 . . . are white. The reason that the plural white color samples are arranged as described above is to easily check the occurrence of an illuminance ununiformity such as shadows.

The object capturing hole 16 is formed in the same shape as that of the square color samples Nos. 111, 113, and 115 . . . .

The above described color samples Nos. 111 to 177 are color-measured as L*a*b* values in advance. Meanwhile, hereinafter, L*a*b* will be abbreviated as Lab. The Lab is a device-independent uniform color space. The Lab values obtained by color-measuring as described above are stored in a memory 24 of the deterioration measuring device 20 to be described later in a state of being paired with positions of the color samples Nos. 111 to 177.

Meanwhile, the object capturing hole 16 (denoted by No. 144 in FIG. 2) is unknown data, and thus, is not color-measured, and there is no object to be stored as colorimetric data.

Also, in the margin portion of the known color body 10, for example, three position checking holes 36a, 36b, and 36c serving as a position checking section are formed. For example, characters, that is, “dark,” “medium,” and “pale” are marked in the vicinity of position checking holes 36a, 36b, and 36c, respectively.

The position checking holes 36a, 36b, and 36c of the known color body 10 are used when a fixed-point measurement is performed on a deterioration state of the object 12.

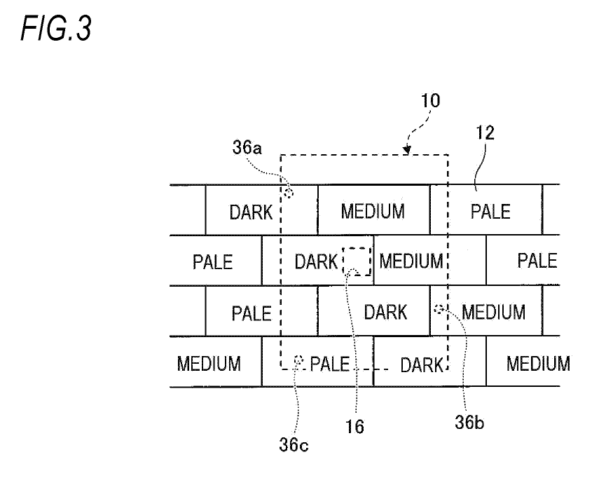

As illustrated in FIG. 3, it is assumed that, for example, the same color that is divided into “dark,” “medium,” and “pale” is painted in the row direction of the object 12, and the paintings of the same color depth are shifted by a half cycle in the column direction. Here, when the position checking hole 36a of the known color body 10 is aligned with “dark” of the object 12, the position checking hole 36b is aligned with “medium” of the object 12, and the position checking hole 36c is aligned with “pale” of the object 12, the object capturing hole 16 may be aligned with a “dark” portion of the object 12, thereby performing a fixed-point measurement.

Also, at least one of the position checking holes 36a, 36b, and 36c may be sufficient, and the position checking holes may be formed according to the state of the object 12. Also, since a portion of the object 12 is captured through the position checking holes 36a, 36b, and 36c by the image capturing device 18, the capturing position of the object 12 may be recorded.

Also, in the exemplary embodiment, as the position checking section, the position checking holes 36a, 36b, and 36c may be used, but the present invention is not limited thereto. For example, “dark,” “medium,” and “pale” portions may be indicated by arrows. Also, instead of characters such as “dark,” “medium,” and “pale,” the same color as that of a portion to be addressed may be formed. When a color paler than other portions is present in the “dark” portion, or a color darker than other portions is present in the “pale” portion, the position checking section may also serve as a determining unit to determine that the known color body 10 is arranged at a wrong position.

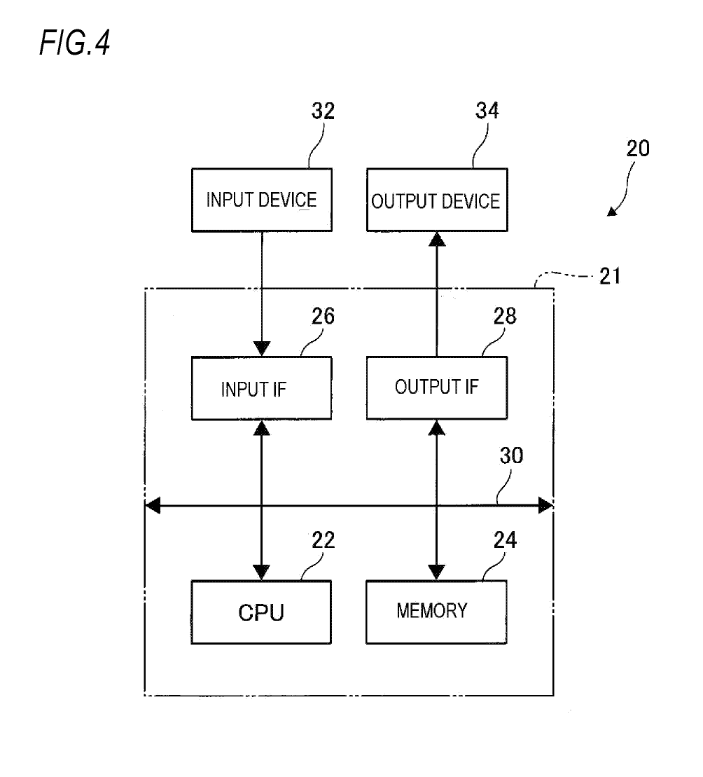

FIG. 4 is a block diagram illustrating the deterioration measuring device 20.

The deterioration measuring device 20 includes a data processor 21. The data processor 21 includes a CPU 22, the memory 24, an input interface 26, and an output interface 28, which are connected through a control bus 30.

The CPU 22 executes a predetermined processing based on a control program stored in the memory 24. An input device 32 is connected to the input interface 26. The input device 32 may include a connector that is directly connected to the above described image capturing device 18 to be used for input, or a device to be used for wireless input through a communication. Also, an output device 34 is connected to the output interface 28. The output device 34 is a display or a printer, through which a result such as processed data is output.

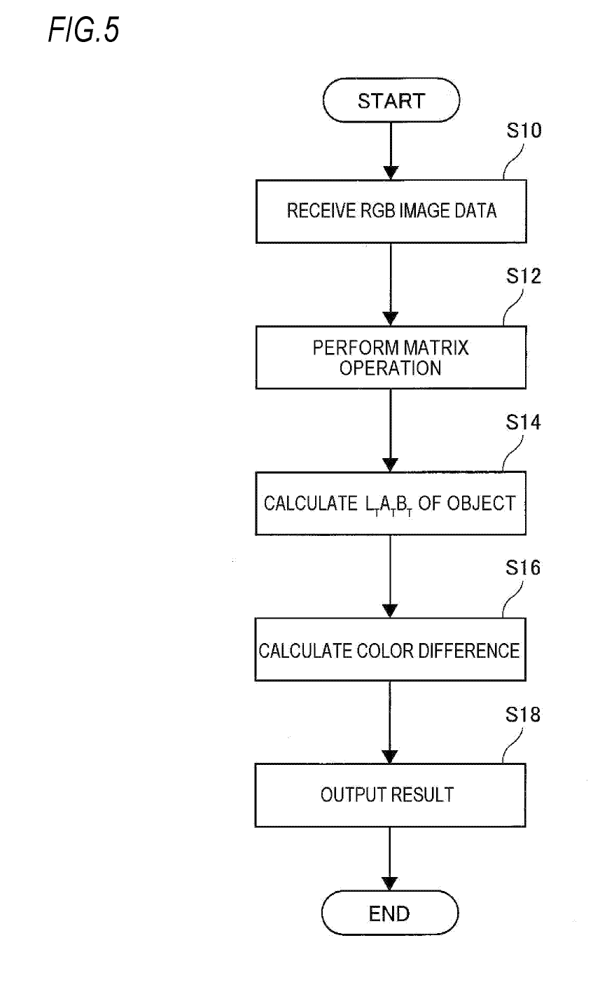

FIG. 5 is a flow chart illustrating a processing flow of the deterioration measuring device 20.

First, in step S10, RGB image data of the color samples 14 of the known color body 10 and the object 12 within the object capturing hole 16, which are obtained through capturing using the image capturing device 18, are received.

Meanwhile, the image data to be adopted include an average value of each of RGB in a region near the center within the color sample 14 having the same color.

In the following step S12, a matrix operation is performed. That is, the RGB image data of the color samples 14 received in step S10 are set as explanatory variables, and a colorimetric value Lab of each of the color samples 14 obtained through colorimetry in advance and stored in the memory 24 is set as an object variable to obtain a matrix through multiple regression.

For example, as expressed in Equation (1) below, a matrix in multiple regression is obtained, and image data RGB are converted into a colorimetric value Lab.

[Equation 1]

^{t}(L,a,b)=M^{t}(R,G,B,1)(t: TRANSPOSED MATRIX M IS A 3×10 MATRIX) (1)

Specifically, Equation (2) below is used.

[Equation 2]

L=(a11,a12,a13, . . . ,a110)^{t}(R,G,B,R²,G²,B²,RG,GB,BR,1)

a=(a21,a22,a23, . . . ,a210)

b=(a31,a32,a33, . . . ,a310) (2)

In the following step S14, RGB data of an image within the object capturing hole 16 of the known color body 10 captured by the image capturing device 18, that is, an image of the object 12 are put in the equation obtained in step S12 to obtain an expected colorimetric value Lₜaₜbₜ of the object.

Meanwhile, in the exemplary embodiment, as expressed in Equation (1), multiple regression is performed by a quadratic equation, but may be performed by a color conversion method such as a three-dimensional table method used in a general color management system instead of the quadratic equation. Also, instead of the multiple regression, a neural network by learning may be used. That is, any method may be used as long as the method is capable of forming color conversion using teacher data (data of explanatory variables and object variables).

In the following step S16, a color difference ΔE between a colorimetric value L₀a₀b₀ on the object in a new product state and a colorimetric value Lₜaₜbₜ obtained in step S14 is calculated. As the colorimetric value L₀a₀b₀ on the new product state, a value obtained through actual colorimetry in a new product state may be used, or a value of the color sample No. 142 of the known color body 10 may be used.

For the calculation of the color difference ΔE, for example, Equation (3) below is used.

[Equation 3]

ΔE=\sqrt{(L₀−Lₜ)²+(a₀−aₜ)²+(b₀−bₜ)²} (3)

Meanwhile, in the example, as expressed in Equation (2), the color difference ΔE is obtained by an Euclidean distance, but, for example, ΔE00 or the like may be used.

Then, in the following step S18, the measured result is output to the output device 34, and the process is ended. As the measured result, ΔE calculated in step S16 may be output as it is. Meanwhile, when ΔE exceeds a predetermined threshold, a message indicating that repairing is needed may be displayed, or a deterioration level, e.g., level 1, level 2, or the like may be output.

Meanwhile, in the exemplary embodiment, the deterioration measuring device 20 includes a personal computer, but the present invention is not limited thereto. For example, the image capturing device 18 may have all or some of functions of the deterioration measuring device 20.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A change degree deriving device comprising:
a receiving unit that receives an image obtained by capturing an object and a known color body, the known color body including a plurality of color samples each of which has a known colorimetric value, and a position checking section used to check a relative position of the known color body with respect to the object;
a conversion rule generating unit that generates a conversion rule used to convert a color of the image received by the receiving unit into a numerical value in a device-independent color space, based on the color samples included in the image received by the receiving unit; and
a converting unit that converts a color of the object included in the image received by the receiving unit into a numerical value in the device-independent color space according to the conversion rule.

2. The change degree deriving device according to claim 1, further comprising:
a determining unit that determines whether the relative position of the known color body with respect to the object is proper based on image data of a portion of the image corresponding to the position checking section.

3. The change degree deriving device according to claim 1, wherein
the position checking section is a hole formed in the known color body.

4. A change degree deriving system comprising:
a capturing unit that captures an image of an object and a known color body, the known color body including a plurality of color samples each of which has a known colorimetric value, and a position checking section used to check a relative position of the known color body with respect to the object;
a receiving unit that receives the image captured by the capturing unit;
a conversion rule generating unit that generates a conversion rule used to convert a color of the image received by the receiving unit into a numerical value in a device-independent color space based on the color samples included in the image; and
a converting unit that converts a color of the object included in the image received by the receiving unit into a numerical value in the device-independent color space according to the conversion rule.

5. The change degree deriving system according to claim 4, further comprising:
a determining unit that determines whether the relative position of the known color body with respect to the object is proper based on image data of a portion of the image corresponding to the position checking section.

6. A known color body comprising:
a plurality of color samples each of which has a known colorimetric value, and
a position checking section used to check a relative position of the known color body with respect to an object.

7. The known color body according to claim 6, wherein
the position checking section is a hole formed in the known color body.

8. The known color body according to claim 6, wherein
the position checking section is an indicator that indicates a position on the object where to align the known color body.

9. The known color body according to claim 7, wherein
the position checking section includes a mark indicating a position on the object where to align the hole, in the vicinity of the hole formed in the known color body.

10. The known color body according to claim 6, wherein
the position checking section is arranged outside the plurality of color samples.
